(19) United States
(12) Patent Application Publication
(10) Pub. No.: US 2009/0214288 A1
(43) Pub. Date: Aug. 27, 2009

(54) Oil Boom QUick Release/Install Apparatus

(76) Inventor: William Keith Nesmith, Ewa Beach, HI (US)

Correspondence Address: DONALD W. MEEKER, 924 EAST OCEAN FRONT, # E, NEWPORT BEACH, CA, 92661, US

(21) Appl. No.: 12/034,660

(22) Filed: Feb. 21, 2008

(51) Int. Cl. F16B 21/00; E02B 15/06; E02B 15/04

(52) U.S. Cl. 403/322.1; 405/67

(57) ABSTRACT

A quick release/install device for attaching any oil containing boom to any wharf or pier. An oil boom bracket with a removable retaining pin loosely holds the boom wall. Each of a series of brackets is attached to a vertical cable system on each piling that allows movement with tidal changes and waves.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to oil containment floating barriers and particularly to a quick release/install apparatus which affixes any standard existing oil containing boom to any wharf or pier structure and allows the attached oil boom to move freely in four directions; the oil boom quick release/install apparatus comprising a series of oil boom mounts each with a removable retaining pin, a first bracket and a second bracket mounted on a concrete or wooden piling of a dock, a cable extending from the first bracket to the second bracket upon which the oil boom mount may travel freely, and a plurality of cables for securing the oil boom quick install/release apparatus to wooden or concrete piling or other like structure.

2. Description of Related Art including Information Disclosed under 37 CFR 1.97 and 1.98

The Oil Pollution Act of 1990 (33 U.S.C. 2701-2761) amended the Clean Water Act and addressed the wide range of problems associated with preventing, responding to, and paying for oil pollution incidents in navigable waters of the United States. It created a comprehensive prevention, response, liability, and compensation regime to deal with vessel- and facility-caused oil pollution to U.S. navigable waters. OPA greatly increased federal oversight of maritime oil transportation, while providing greater environmental safeguards by:
Mandating contingency planning for containment and recovery,
Enhancing federal response capability,
Broadening enforcement authority,
Increasing penalties,
Creating new research and development programs
Increasing potential liabilities, and
Significantly broadening financial responsibility requirements.
   Piers and wharfs that moor or berth vessels conducting fueling operations require an oil spill containment system installed for environmental protection.

Prior oil containment booms generally require hours of labor to install and uninstall due to an elaborate attaching system of cables and bolts. Routine installation or removal of oil containment booms for maintenance, replacement, and cleaning may become very expensive due to the man hours of labor required in uninstalling and reinstalling the oil boom in addition to the time for maintenance and cleaning. Many times it is necessary to uninstall and reinstall oil containment booms as quickly as possible. One example is when a large oil containment boom needs to be drawn in to confine a smaller area as when a spill from refueling or other type spill occurs within the larger boom and the boom should be made smaller to act as a net confining the oil to a smaller spill area. Prior art booms do not lend themselves to such speedy conversions.

U.S. Pat. No. 4,016,726, issued Apr. 12, 1977 to Campbell, indicates a connector hinge for attaching oil spill containment booms having a male cylindrical connector which fits loosely within a female cylindrical connector to allow easy movement of both connectors in both a vertical and horizontal direction. A resilient gasket is disposed within the male cylindrical connector such that the gasket forms an oil-tight seal between the male connector and female connector. The female connector is tapered along its length to allow easy disposition of the male member within its cylindrical cavity. Both the male and female connectors can be attached to a floating oil spill containment boom, a substantially immovable object such as a pier or jetty, or a floating tow assembly. The loose fit between the male and female connectors allows the connector hinge to adjust to tidal variations as well as additionally aiding in placement of the male connector within the female connector. The gasket material is formed of foam rubber, rubber, or any other suitable resilient material capable of forming an oil-tight seal. The gasket is formed in either a rectangular shape or beaded to aid in securing the gasket to the male connector.

U.S. Pat. No. 5,971,660, issued Oct. 26, 1999 to Duchesneau, puts forth an extensible barrier to retain a hydrocarbon slick between a fixed and a floating structure to confine potential oil spills while transfer in, between a ship and a wharf, or between two ships. It is made of a barrier that is fitted on a IS beam fixed on the wharf on which the barrier can be moved vertically with a float, according to the waterline. This barrier is mobile and detachable, of a mechanical. pneumatic or hydraulic type, and can be easily operated by one man. A waterproof canvas is placed on the mechanical barrier to confine the oil slick; a spring thrusts a shoe against the hull of the ship and is kept in place by magnets. A mechanical arm slides against the hull, with the help of balls. A hydraulic alternative stops oil diffusion by creating a current. A pneumatic alternative uses a curtain of bubbles that burst at the surface and hold the oil while creating a current.

U.S. Pat. No. 3,973,406, issued Aug. 10, 1976 to Casey, is for a collapsible, quickly deployable floating containment boom which comprises an elongated curtain-like partition of strong, flexible, impervious material supported in a substantially vertical position in the water by a plurality of outrigger-type flotation units spaced along the partition. The partition is in the form of an elongated, flexible belt which has a smooth surface on the side opposite the flotation units, and the smooth side surface engages the material to be contained by the barrier. The barrier has sufficient longitudinal flexibility to encircle an oil spill or a ship that might be unloading or loading oil, and the outrigger flotation units support the partition or belt at a height above the surface of the water which is approximately ⅓ to ½ of the partition width. Each outrigger flotation unit comprises a frame and a float. The frame is connected to the side of the partition or belt for pivoting action about a vertical axis extending parallel and immediately adjacent to the side of the belt, and the float is connected to the frame for pivoting action about a horizontally extending axis. This articulation of the frame and float provides a self-stabilizing action of the outrigger flotation units. It also permits each float and frame to be folded back flat against the side of the belt to facilitate deployment of the floating barrier through narrow passageways such as between ships and piers. This articulation also permits the barrier to be folded in accordion fashion for compact storage and transport. The device can be used to connect an end of the floating barrier to a pier or other fixed object and yet permits the barrier to move up and down with the changes in the tide level.

U.S. Patent Application #20070201953, published Aug. 30, 2007 by LeBlanc, is for a containment boom guide system for guiding and containing a floating containment boom to a fixed structure such as a pier, ship, column, dock, sea wall, or other like structure. The guide system is made up of one or more boom guide(s) and allows lateral and vertical movement of the floating containment boom while keeping the boom secure to the fixed structure.

U.S. Pat. No. 5,538,359, issued Jul. 23, 1996 to Wadle, provides a quick release boom connector for a remotely disconnectable floating containment boom, which includes male and female portions of a connector and a release element which holds the male and female portions together when they are operatively engaged. The containment boom includes a remote activating element attached to the release element. The remote activating element can disengage the release element from the male and female portions of the boom sections from a remote location, thereby permitting the boom sections to disconnect and separate.

U.S. Pat. No. 5,190,402, issued Mar. 2, 1993 to Vick, shows a fire resistant boom connector for connecting adjacent oil containment booms. The boom connector includes cooperating connector portions, each of which includes a base portion, an elbow portion, and an engaging portion. A slot bounded by the base portion, the elbow portion, and the engaging portion is adapted for receipt of a cooperative engaging portion to interengage the connector portions.

U.S. Pat. No. 4,003,206, issued Jan. 18, 1977 to Tanksley, claims a universal end connector for releasably coupling together aligned ends of a floating boom or the like. The end connector is formed with a normally vertically extending body having a first side adapted for mounting to the end of the boom and a second coupling side formed as a yoke-like bifurcated side having a pair of spaced apart neck portions terminating in enlarged head portions. The neck and head portions define a throat and enlarged cavity therebetween dimensioned for receipt of the head and neck of a similarly formed second end connector. The throat and cavity of the end connectors are open at least one of a top and a bottom end thereof to permit selective positioning of the end connectors in coupled and uncoupled relation. The enlarged head of the end connector is preferably formed with inwardly facing and inclined surfaces on either side of the head so as to cause the head portions to be pulled together and narrow the throat to enhance coupling under normal loading of the connector.

U.S. Pat. No. 3,766,738, issued Oct. 23, 1973 to Gauch, discloses an apparatus for supporting a floating boom which forms a barrier on the surface of a liquid and for forming a seal between the end of the boom and a fixed structure, for example a dock. The apparatus allows lateral and vertical displacement of the boom with changes of wind, current, or tide while maintaining the seal. A deformable, resilient wall held in pressure contact with the dock while supported on a vertically and laterally movable frame displaceable along a vertical pipe spaced from the dock maintains the seal to prevent oil or other pollutants on the surface of the liquid from passing between the end of the boom and the dock.

U.S. Pat. No. 4,348,136, issued Sep. 7, 1982 to Donovan, illustrates a spill containment device adapted for attaching a containment boom to any ferromagnetic surface at the water line, the device including a base member in the form of an elongated arm having a medial portion and opposite end portions, a float at the medial portion of the arm for imparting buoyancy to the device relative to a body of water, a magnet carried by a first of the opposite end portions for magnetically attaching the device to a ferromagnetic surface, a second of the opposite end portions including a loop for connecting a line thereto for applying a force to the device to detach or disconnect the magnetic connection thereof with an associated ferrometallic surface, and first and second couplers for respectively fixedly and movably connecting a containment boom to the device.

U.S. Pat. No. 3,984,987, issued Oct. 12, 1976 to Light, Jr., provides an apparatus for a marine facility which prevents silt from entering the facility and also provides spill containment. A floating barrier provides the containment and a flexible curtain attached to the barrier and having devices anchoring the curtain to the floor of the water prevents silt from entering the facility. The barrier rises and falls with the tides and openings in the curtain permits the tidal flow to enter and leave the facility. The apparatus is attached to fixed structure in a suitable manner. The barrier and curtain can be moved to permit passage of a ship.

What is needed is a quick release and quick install apparatus which affixes any standard existing oil containing boom to any wharf or pier structure and allows the attached oil boom to move freely in four directions; the oil boom quick release/install apparatus comprises an oil boom mount with a removable retaining pin, a first bracket and a second bracket mounted on a concrete or wooden piling of a dock, a cable extending from the first bracket to the second bracket upon which the oil boom mount may travel freely, and a plurality of cables for securing the oil boom quick install/release apparatus to wooden or concrete piling or other like structure.

### BRIEF SUMMARY OF THE INVENTION

An object of the present invention is to provide a quick release/install apparatus which affixes any standard existing oil containing boom to any wharf or pier structure and allows the attached oil boom to move freely in four directions; the oil boom quick release/install apparatus comprises an oil boom mount with a removable retaining pin, a first bracket and a second bracket mounted on a concrete or wooden piling of a dock, a cable extending from the first bracket to the second bracket upon which the oil boom mount may travel freely, and a plurality of cables for securing the oil boom quick install/release apparatus to wooden or concrete piling or other like structure.

Another object of the present invention is that it is designed to work with an Oil Spill Permanent Containment Boom and shall accommodate any type of Permanent Environmental Boom on the commercial market (Parker System or Slick-Bar). One more object of the present invention is to provide a system manufactured with composite material and designed for long life and low to no maintenance.

An additional object of the present invention is to provide a system that will accommodate any size of wood piles or square concrete piles despite pile irregularity or obstructions.

In brief, the oil boom quick install/release apparatus system of the present invention is used in conjunction with an environmental permanently installed oil boom. The oil boom is installed on piers in ports that perform vessel fueling operations in order to contain accidental petroleum spills. The oil boom quick install/release apparatus is secured to the pier's wooden or concrete pilings, and the permanent oil boom is attached to the oil boom apparatus using a retaining pin. The oil boom quick install/release apparatus is attached to pilings using a guide cable every 20-25 ft. throughout the length of the pier, while allowing the oil boom to move vertically and laterally with tidal changes and waves.

An advantage of the present invention is it is designed to work with an Oil Spill Permanent Containment Boom and shall accommodate any type of Permanent Environmental Boom on the commercial market (Parker System or Slick-Bar).

Another advantage of the present invention is that it provides a system that will accommodate any type of pier or wharf, and allow the attached oil boom to move freely in four directions.

One more advantage of the present invention is that it provides a quick install and quick release oil boom retaining apparatus system for securing and guiding permanently installed oil spill containment booms in any tidal change.

An additional advantage of the present invention is that it provides a system that is designed for long life and low to no maintenance.

A further advantage of the present invention is that it provides a system that will accommodate any size of wood piles or square concrete piles despite pile irregularity or obstructions.

Still another advantage of the present invention is that it is easy and time saving to install or remove boom for maintenance, replacement, and cleaning.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a perspective view of the quick install and quick release oil spill containment boom of the present invention installed on a piling;

FIG. 2 is a perspective view of the quick install and quick release oil spill containment boom of FIG. 1 installed on a piling with an oil spill containment boom attached thereto;

FIG. 3 is a side elevational view of the quick install and quick release oil spill containment boom of FIG. 1 installed on a piling with an oil spill containment boom attached thereto showing the pier and the water level.

### DETAILED DESCRIPTION OF THE INVENTION

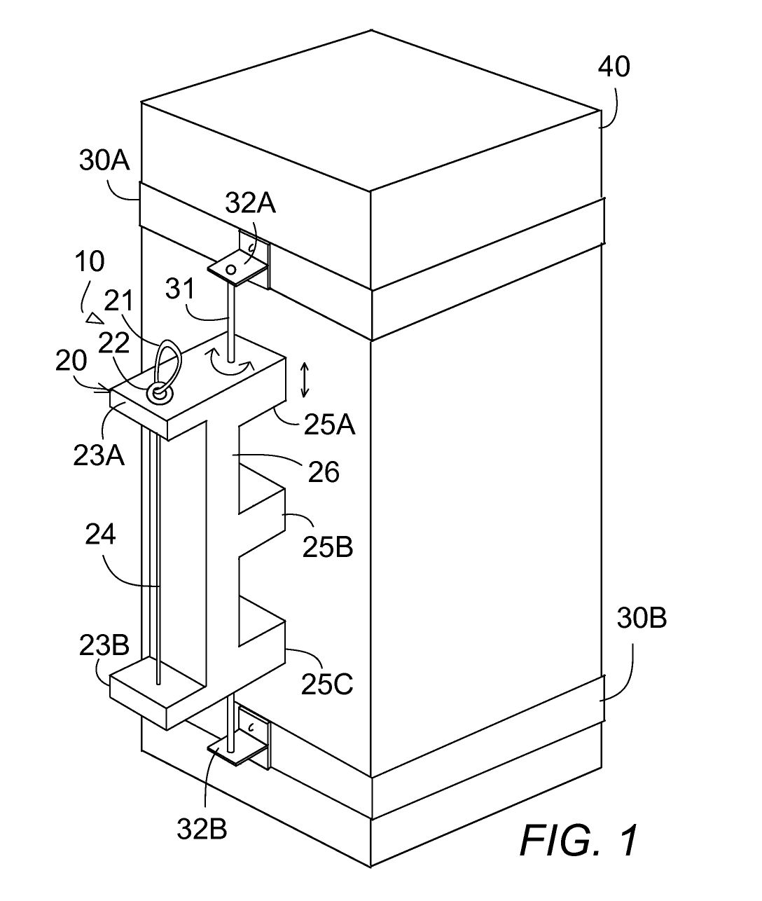

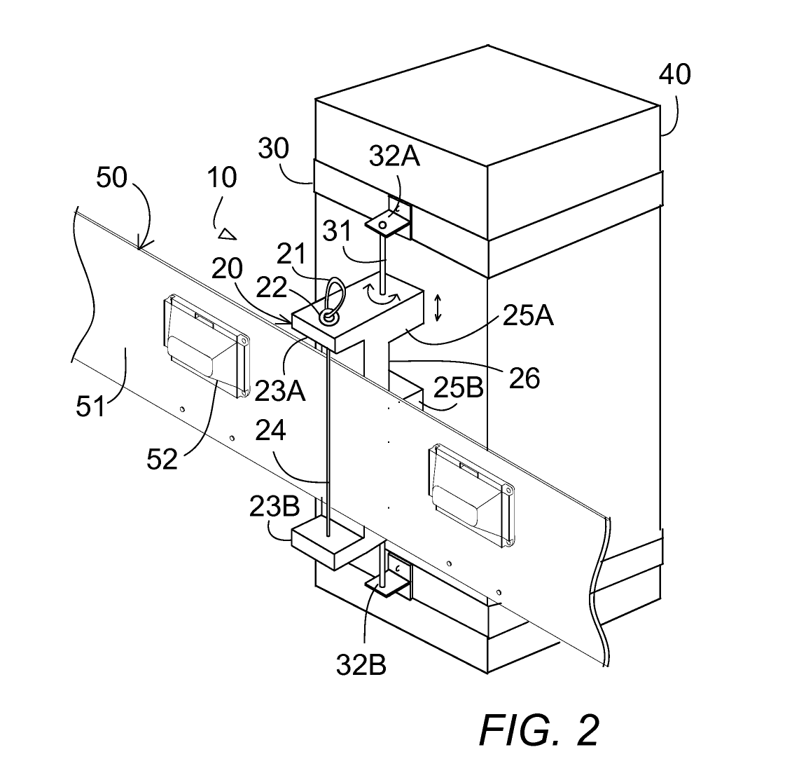

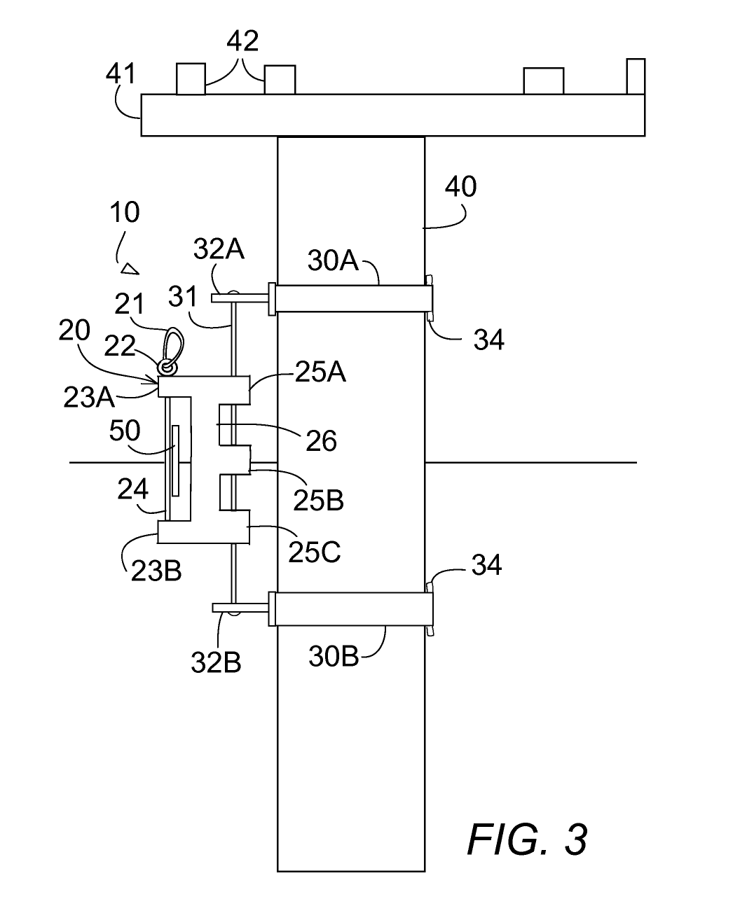

In FIGS. 1-3, a quick install/quick release oil boom retaining apparatus system 10 provides a series of quick install and quick release oil boom retaining apparatuses 20 installed along a length of an oil boom 50 for securing and guiding permanently the installed oil spill containment boom in any tidal change (2-20 feet) or wave movement.

As shown in FIGS. 1-3, each oil boom quick install/quick release retaining apparatus 10 comprises an elongated body 26 having a pair of boom brackets 23A and 23B extending orthogonally from a forward side, one at a top end and the other at a bottom end. The boom brackets are spaced apart by a distance greater than the height of an oil spill containment boom 50 and secured by the apparatus between the boom brackets with a quick release pin 24 removably installed between the boom brackets 23A and 23B. The oil boom 50 rests therein to create a boom containment space between the pin 24, the boom brackets 23A and 23B, and the elongated body 26 so that the oil boom is free to move at least laterally, vertically, and from the pin to the elongated body within the containment space with the motion of the water. The quick release pin 24 is removably attached between the boom brackets 23A and 23B, and the oil boom 50 is instantly released by removing the pin 24 by pulling on the hand grip 21. The hand grip 21 is held in place with the pin pull ring 22.

FIGS. 1-3 also show at least two cable holding brackets 25A, B and C spaced apart vertically and extending orthogonally from a rearward side of the elongated body 26, each cable holding bracket having an opening vertically therethrough for receiving a cable 31 slidably therethrough. At least two cable mounting brackets 32A and 32B are attached to a vertical structure 40 in a body of water and these cable mounting brackets 32A and 32B are spaced vertically apart by a height equal to a tidal change in the body of water with the cable 31 attached therebetween. The cable 31 is inserted through the cable holding brackets 32A and 32B on the elongated body 26 so that the elongated body holding the oil boom 50 floats vertically up and down and laterally on the guide cable, sliding on the cable in response to tidal and wave movement in the body of water. The length of guide cable 31 is determined by tide plus 3 feet. Having a number of the oil boom retainers 10 in place along at least a portion of the length of the oil spill containment boom 50 provides a quick install and quick release oil boom retaining apparatus system for securing and guiding permanently installed oil spill containment booms in any tidal change.

The oil boom quick install and release apparatus 10 is comprised of a linear low density polyethylene (LLDPE) composite, a non-corrosive material having higher tensile strength and higher impact and puncture resistance than other composites. It also has a flexibility and environmental stress cracking resistance to deflect energy caused by ships and service craft, as well as resistance to petroleum and ultraviolet radiation for prolonged life.

In FIGS. 1-3, the top cable mounting bracket 32A is comprised of stainless steel and is attached to wooden and concrete piles 40 with a stainless steel cable/strapping 30A with fasteners, and a bottom cable mounting bracket 32B is also made of stainless steel and is attached to wooden or concrete piles 40 with a stainless steel cable/strapping 30B having stainless steel fasteners 34. As shown in FIGS. 1-3, at least two and upward to four stainless steel cables/strapping 30 are used for securing the oil boom quick install/release apparatus to wooden or concrete pilings or other like structures.

The width of the device is preferably 3 inches, the depth is 6″ and the length is 28⅛″.

In use, the oil boom quick release/quick innstall apparatus 10 of the present invention is designed to work with an Oil Spill Permanent Containment Boom 50 and will be manufactured with composite material, designed for long life and low to no maintenance. The oil boom quick release/quick innstall apparatus shall accommodate any type of permanent environmental boom on the commercial market (Parker System or Slick-Bar). The apparatus system will accommodate any type of pier or wharf, any size of wood piles or square concrete piles, despite pile irregularity or obstructions, and allow the attached oil boom to move freely in four directions.

At least two cable mounting brackets 32A and 32B are attached by strapping 30 around each of a series of pilings 40 with the brackets spaced apart vertically by at least the height of the tidal change to allow the brackets 20 to go up and down with the tidal change and wave action. At each bracket 20 the pin 24 is pulled out, the boom 50 slipped into the space between the pin brackets 32A and 32B and the pin 24 reinstalled to retain the boom therein loosely to allow motion of the boom with the water. The brackets 20 can pivot around the cable 31 and slide up and down on the cable, and the boom 50 can move vertically, laterally and from front to back between the pin 24 and the bracket 20 so that the boom wall 51 is always maintained half on top of the water and half below the water based on the float 52 being at the surface of the water to contain the oil spill.

It is understood that the preceding description is given merely by way of illustration and not in limitation of the invention and that various modifications may be made thereto without departing from the spirit of the invention as claimed.

What is claimed is:

1. A quick install/quick release oil boom retaining apparatus system for securing and guiding permanently installed oil spill containment booms in any tidal change, the system comprising:
a series of quick install and quick release oil boom retaining apparatuses installed along a length of an oil boom, each quick install/quick release retaining apparatus comprising an elongated body having a pair of boom brackets extending orthogonally from a forward side, one at a top end and the other at a bottom end, the boom brackets spaced apart by a distance greater than the height of an oil spill containment boom secured by the apparatus between the boom brackets; a quick release pin removably installed between the boom brackets with the oil boom resting therein to create a boom containment space between the pin, the boom brackets and the elongated body so that the oil boom is free to move at least laterally, vertically, and from the pin to the elongated body within the containment space due to water motion with the pin removably attached between the boom brackets and the oil boom is instantly released by removing the pin; at least two cable holding brackets spaced apart vertically and extending orthogonally from a rearward side of the elongated body, each cable holding bracket having an opening vertically therethrough for receiving a cable slidably therethrough; at least two cable mounting brackets attached to a vertical structure in a body of water, the cable mounting brackets spaced vertically apart by a height equal to a tidal change in the body of water and a cable attached therebetween, the cable inserted through the cable holding brackets on the elongated body so that the elongated body holding the oil boom moves vertically up and down sliding on the cable in response to tidal and wave movement in the body of water so that having a number of the oil boom retainers in place along at least a portion of the length of the oil spill containment boom provides a quick install and quick release oil boom retaining apparatus system for securing and guiding permanently installed oil spill containment booms in any tidal change.

2. The system of claim 1 wherein the oil boom quick install and release apparatus is comprised of a linear low density polyethylene (LLDPE) composite as a non-corrosive material having higher tensile strength and higher impact and puncture resistance than other composites and a flexibility and environmental stress cracking resistance to deflect energy caused by ships and service craft and the apparatus has resistance to petroleum and ultraviolet radiation for prolonged life.

3. The system of claim 1 wherein a top mounting bracket made of stainless steel is attached to wooden and concrete piles with stainless steel cable with fasteners and a bottom mounting bracket is made of stainless steel and is attached to a wooden or concrete piles with stainless steel cable with fasteners.
